(19) United States
(12) Patent Application Publication
(10) Pub. No.: US 2011/0168853 A1
(43) Pub. Date: Jul. 14, 2011

(54) MASONRY UNIT WALL PIPE SUPPORT SYSTEM

(76) Inventor: Anthony F. Nolfi, JR., Lowellville, OH (US)

(21) Appl. No.: 12/980,458

(22) Filed: Dec. 29, 2010

Related U.S. Application Data
(60) Provisional application No. 61/294,680, filed on Jan. 13, 2010.

(51) Int. Cl. F16L 3/08

(52) U.S. Cl. 248/73

(57) ABSTRACT

A masonry unit wall support system and method for supporting one or more pipes within a masonry unit wall includes a compressible support structure containing one or more holes for one or more pipes. The compressible support structure is compressively inserted into a hollow core cavity of a masonry unit to create a relatively immovable support for one or more pipes inserted through one or more holes that may be formed in the support structure either before or after the support structure is compressively inserted into the hollow core cavity.

### CROSS-REFERENCE TO RELATED APPLICATIONS

This application claims the benefit of U.S. Provisional Application Ser. No. 61/294,680, filed Jan. 13, 2010, the entire disclosure of which is incorporated herein by reference.

### FIELD OF THE INVENTION

This invention relates to a support system and method for supporting one or more pipes for plumbing or other applications within one or more hollow core cavities of a masonry unit wall.

### SUMMARY OF THE INVENTION

The support system and method of the present invention includes a support structure made out of a suitable compressible material for providing a support for one or more pipes inside a cavity of a hollow core masonry unit wall. The masonry units (blocks) may either be cement masonry units (CMU) or synthetic masonry units (SMU).

A suitable tool such as a coring tool or similar type cutting tool may be used to create one or more paths/holes through the support structure for closely receiving one or more pipes to be supported in the hollow core cavity of a masonry unit wall, with, typically (but not necessarily), a friction fit. The support structure is compressively inserted into one of the hollow core cavities in a masonry unit wall to provide a friction fit of the support structure within the cavity to create a relatively immovable support for the pipe. One or more holes may be formed in the support structure for insertion of one or more pipes through the respective holes either before or after the support structure has been compressively inserted into a masonry unit cavity.

### BRIEF DESCRIPTION OF THE DRAWINGS

FIG. 1 is a schematic perspective view showing two pipes supported by a compressible support structure compressively inserted within a hollow core cavity of a masonry unit in accordance with the present invention.

FIG. 2 is a schematic perspective view similar to FIG. 1 but showing the support structure with the pipes extending through holes therein prior to inserting the support structure into the hollow core cavity of a masonry unit.

FIG. 3 is an enlarged schematic perspective view of an exemplary support structure of the present invention.

FIG. 4 is a top plan view of the support structure of FIG. 3.

FIG. 5 is a side elevation view of the support structure of FIG. 3.

FIG. 6 is a schematic perspective view of a masonry unit having irregularly shaped hollow core cavities.

FIG. 7 is a schematic illustration of different size coring tools that may be used to form holes in the support structure compatible in size to one or more pipes to be installed in the support structure of the present invention.

### DETAILED DESCRIPTION OF THE INVENTION

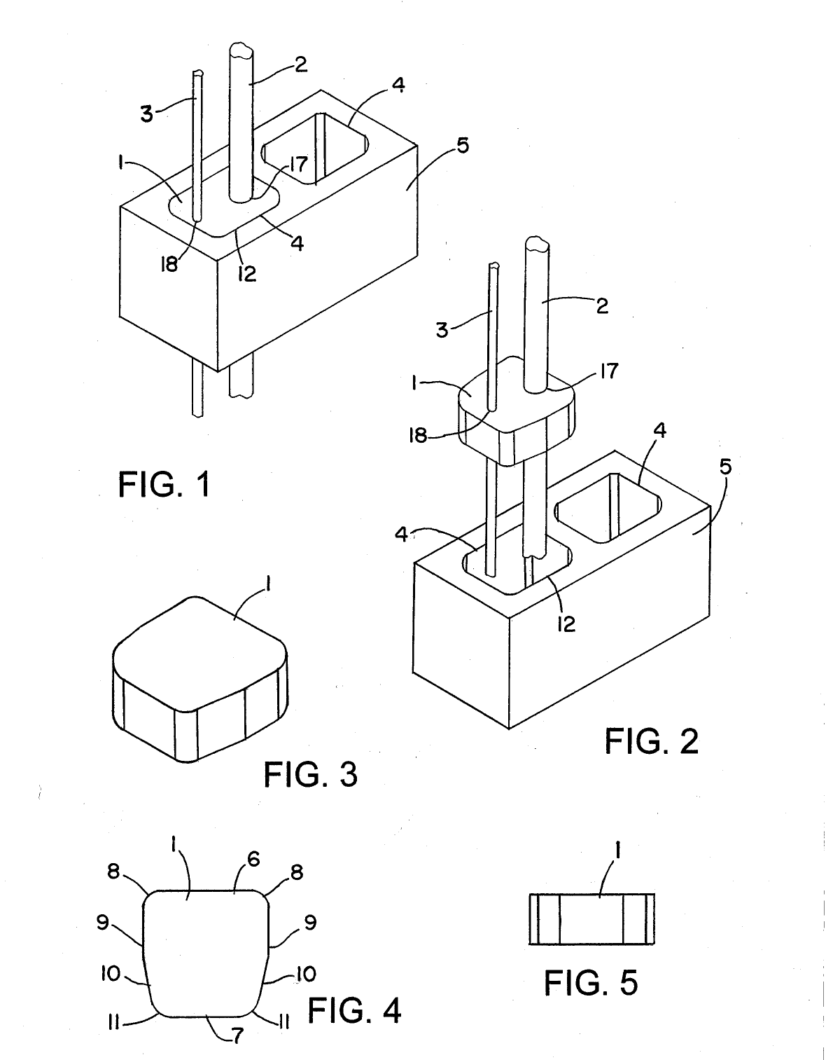

Referring now in more detail to the drawings, and initially to FIG. 1, there is shown one form of compressible support structure 1 of the present invention being used to create a relatively immovable support for one or more pipes 2, 3 for plumbing or other applications within a hollow core cavity 4 of a masonry unit 5. The masonry units (blocks) used to make a masonry unit wall may either be cement masonry units (CMU) or synthetic masonry units (SMU) of different sizes (e.g., 6 inch, 8 inch, 10 inch and 12 inch).

One such exemplary support structure 1 is schematically shown in FIGS. 3-5, and is desirably made of a suitable compressible polymeric material that is sufficiently compressible, (and if need be, trimable) to fit into a hollow core cavity of a masonry unit and provide sufficient holding force to create a relatively immovable pipe support. Some exemplary compressible polymeric materials from which the support structure may be made are polypropylene foam, polyurethane foam, polyethylene foam, polyester foam and expanded polystyrene.

Each support structure 1 is desirably shaped to facilitate compressively fitting the support structure into a particular hollow core cavity size, which is unique to each size of masonry unit, to provide sufficient holding force for creating a relatively immovable support for one or more pipes with no additional modifications (i.e., trimming). However, some trimming of the support structure may be performed if needed.

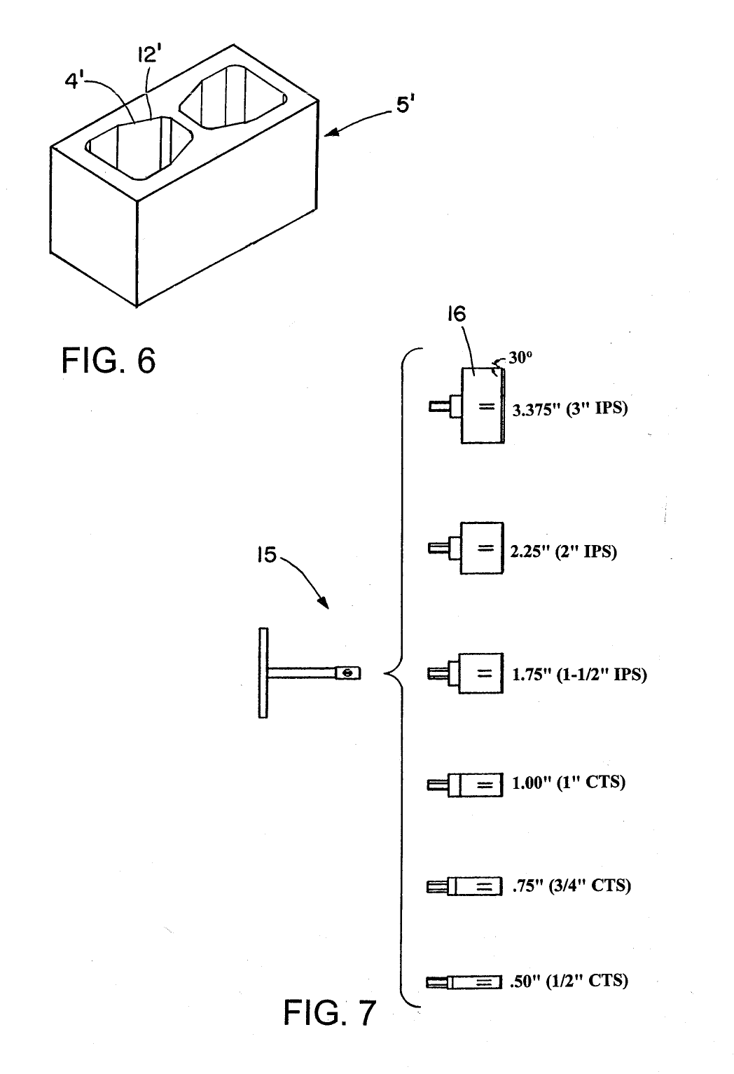

By way of example, one such support structure 1 shown in FIGS. 3-5 may have a maximum width of approximately 5½ inch, a length of approximately 5⅝ inch and a thickness of approximately 2¼ inch. Also one end 6 of the support structure may be somewhat wider than the other end 7 and may have radiused corners 8 of approximately ¾ inch radius, whereas opposite sides 9 of the support structure may have side portions 10 that taper inwardly at an angle of approximately 11° to the narrower end 7, which may have radiused corners 11 of approximately 1 inch radius. This particular shape facilitates fitting of the support structure into a hollow core cavity of an 8 inch masonry unit/block, which is approximately 5⅛ inch by approximately 6 3/16 inch, and may either have a substantially uniform profile shape 12 as shown in FIGS. 1 and 2 or an irregular profile shape 12′ as shown in FIG. 6.

A kit 15 of different size coring tools 16 such as shown in FIG. 7 may be provided for forming different size paths/holes 17, 18 through the support structure 1 compatible in size to one or more pipes 2, 3 to be installed in the support structure and the masonry unit wall (see FIGS. 1 and 2). Such holes 17, 18 are most typically formed in the support structure 1 and the pipes 2, 3 inserted through the respective holes 17, 18 before the support structure has been inserted into the hollow core cavity 4 of a masonry unit (block) 5 as schematically shown in FIG. 2. However, the support structure 1 may be installed in the hollow core cavity before the holes are cut in the support structure and the pipes are inserted therethrough if desired.

When properly installed, the support structure will provide a relatively immovable support for the pipes by using compression of the support structure material to provide a friction fit of the support structure within the hollow core cavity of a masonry unit wall. Also the support structure provides a certain degree of insulation value for the pipes and a certain degree of protection of the pipes from ultraviolet rays.

Although the invention has been shown and described with respect to a certain embodiment, it is obvious that equivalent alterations and modifications will occur to others skilled in the art upon the reading and understanding of the specification. In particular, with regard to the various functions performed by the above-described components, the terms used to describe such components are intended to correspond, unless otherwise indicated, to any component which performs the specified function of the described component (e.g., that is functionally equivalent), even though not structurally equivalent to the disclosed component which performs the function of the herein illustrated exemplary embodiment of the invention. In addition, while a particular feature of the invention may have been described with respect to only one embodiment, such feature may be combined with one or more other features as may be desired and advantageous for any given or particular application.

What is claimed is:

1. A masonry unit wall pipe support system for supporting one or more pipes within a masonry unit wall, the system comprising a compressible support structure containing one or more holes for one or more pipes, the compressible support structure being compressively inserted into a hollow core cavity of a masonry unit to provide a friction fit of the support structure within the hollow core cavity to create a relatively immovable support for the one or more pipes extending through the one or more holes in the support structure.

2. The system of claim 1 wherein the compressible support structure is sized to be compressively fitted within a hollow core cavity of a masonry unit without having to trim the support structure.

3. The system of claim 1 wherein the support structure is made of a compressible polymeric material.

4. The system of claim 1 wherein the one or more pipes have a friction fit in the one or more holes in the support structure.

5. The system of claim 1 wherein one or more coring tools are used to form the one or more holes through the support structure.

6. A method of supporting one or more pipes within a masonry unit wall comprising the steps of compressively inserting a compressible support structure into a hollow core cavity of a masonry unit to provide a friction fit of the support structure within the hollow core cavity, forming one or more holes through the support structure, and inserting one or more pipes through the one or more holes.

7. The method of claim 6 wherein the support structure is made of a compressible polymeric material.

8. The method of claim 7 wherein the compressible support structure is sized to be compressively fitted within the hollow core cavity without having to trim the support structure.

9. The method of claim 7 wherein the support structure is trimmed before being compressively inserted into the hollow core cavity.

10. The method of claim 6 wherein one or more coring tools are used to form the one or more holes through the support structure.

11. The method of claim 6 wherein the one or more holes are formed through the support structure before the support structure is compressively inserted into the hollow core cavity.

12. The method of claim 11 wherein the one or more pipes are inserted through the one or more holes before the support structure is compressively inserted into the hollow core cavity.

13. The method of claim 6 wherein the one or more holes are formed through the support structure and the one or more pipes are inserted into the one or more holes after the support structure has been compressively inserted into the hollow core cavity.

14. The method of claim 6 wherein the support structure has an irregular profile shape sized to be compressively inserted into a hollow core cavity either having a substantially uniform profile shape or an irregular profile shape.

15. The method of claim 14 wherein the support structure has opposite ends, one of the ends being a wider end and the other end being a narrower end.

16. The method of claim 15 wherein the support structure has opposite sides each having side portions that taper inwardly from the wider end to the narrower end.

17. The method of claim 16 wherein the support structure has radiused corners at opposite ends.

18. The method of claim 17 wherein the radiused corners at the wider end have a smaller radius than the radiused corners at the narrower end.
